(19) United States
(12) Patent Application Publication
(10) Pub. No.: US 2025/0156725 A1
(43) Pub. Date: May 15, 2025

(54) SYSTEM AND METHOD FOR HYBRID CLOUD MACHINE LEARNING

(71) Applicant: Royal Bank of Canada, Toronto (CA)

(72) Inventors: Nicholas PRAYOGO, Jakarta (ID); Syed Salman ALI, Scarborough (CA); Ehsan AMJADIAN, Milton (CA); Steven ZHANG, Scarborough (CA); Brijesh JETHVA, Brampton (CA); Danny HUI, Toronto (CA)

(21) Appl. No.: 18/949,795

(22) Filed: Nov. 15, 2024

Related U.S. Application Data
(60) Provisional application No. 63/599,096, filed on Nov. 15, 2023.

(51) Int. Cl. G06N 3/098

(52) U.S. Cl. CPC G06N 3/098

(57) ABSTRACT

Methods, systems, and techniques for applying machine learning in a hybrid cloud computing environment. A request to perform a forecasting task is received at a private cloud endpoint. The task may be, for example, a sequential forecasting task such as volume forecasting or anomaly detection based on historical log data. A proxy is used to route the request to a trained machine learning model running in a public cloud by connecting the private cloud endpoint to the public cloud endpoint. The proxy can also select one of multiple public clouds and one of multiple trained machine learning models to which the request is routed.

### CROSS-REFERENCE TO RELATED APPLICATION

The present application claims priority to U.S. provisional patent application No. 63/599,096 filed on Nov. 15, 2023, and entitled, “System and Method for Hybrid Cloud Machine Learning”, the entirety of which is hereby incorporated by reference herein.

### TECHNICAL FIELD

The present disclosure is directed at methods, systems, and techniques for applying machine learning in a hybrid cloud computing environment.

### BACKGROUND

Volume prediction and anomaly prediction are two examples of applications for which a trained machine learning model may be used for predictive purposes, particularly in the context of data logging. “Volume prediction” in the context of data logging typically refers to forecasting the volume of data that a system is expected to generate over a specific time period, with a view to ensuring proper computing resources are allocated to process that data. “Anomaly prediction” in the context of data logging refers to reviewing data logs to identify anomalies in the form, for example, of unusual or unexpected patterns or events with a view to subsequently remedying or otherwise addressing those anomalies. For example, an anomaly may be the result of a system failure or a security breach that requires rectification.

### SUMMARY

According to a first aspect, there is provided a method for applying machine learning in a hybrid cloud computing environment, the method comprising: receiving, at a private cloud endpoint, a request to perform a forecasting task; and using a proxy to route the request to a trained machine learning model in a public cloud.

The forecasting task may be a sequential forecasting task. For example, the forecasting task may be at least one of volume forecasting or anomaly detection.

The forecasting task may be both of the volume forecasting and anomaly detection, and the anomaly detection may be performed using a result of the volume forecasting.

The trained machine learning model may be based on a transformer architecture or a temporal convolutional network architecture.

Prior to routing the request, the proxy may interpret the request to determine to which of multiple trained machine learning models to route the request. The trained machine learning model to which the request is routed may be one of the multiple trained machine learning models.

The proxy may determine to which of the multiple trained machine learning models to route the request based on at least one of speed, accuracy, or cost constraints.

Prior to routing the request, the proxy may determine to which of multiple public clouds to route the request. The public cloud to which the request is routed may be one of the multiple public clouds.

The proxy may perform a health check on the public cloud to which the request is routed prior to routing the request.

The request may be textual and the proxy may apply a transformer-based architecture to interpret the request.

The method may further comprise, prior to using the proxy to route the request, retrieving account credentials for the public cloud. The account credentials may be used to access the public cloud when routing the request to the trained machine learning model.

The method may further comprise whitelisting a connection between an egress address of the private cloud and an address range of the public cloud.

Using the proxy to route the request may comprise wrapping prediction code of the trained machine learning model under an application programming interface route.

Prior to using the proxy to route the request, the proxy may spin up the trained machine learning model on the public cloud.

The request may be received in the form of an application programming interface call.

The private cloud endpoint may mirror a public cloud endpoint of the public cloud.

According to another aspect, there is provided a method of applying machine learning in a hybrid cloud computing environment for forecasting, the method comprising: receiving, at a private cloud endpoint of a private cloud, a request to perform a forecasting task; processing the request with a proxy to determine, based on the request, a machine learning model in a public cloud suitable for the forecasting task according to one or more parameters; routing the request with the proxy to a public cloud endpoint of the public cloud for processing by the machine learning model; processing, at the public cloud, the request with the machine learning model to perform the forecasting task; and routing results of the forecasting task output by the machine learning model from the public cloud endpoint to the private cloud endpoint.

The forecasting task may be a sequential forecasting task of volume forecasting and/or anomaly detection.

The anomaly detection may be performed using a result of the volume forecasting.

The machine learning model may be based on a transformer architecture or a temporal convolutional network architecture.

The machine learning model may be one of a plurality of trained machine learning models.

The one or more parameters for the determination of the machine learning model may be: speed, accuracy, cost constraints, or combinations thereof.

The determination of the machine learning model suitable for the forecasting task by the proxy may comprise ranking the one or more parameters of the plurality of trained machine learning models using non-binary values.

The method may further comprise: determining, by the proxy prior to routing the request, which of multiple public clouds to route the request, and he public cloud to which the request is routed may be one of the multiple public clouds.

The method may further comprise: performing, by the proxy prior to routing the request, a health check on the public cloud to which the request is routed.

The request may textual and the proxy may apply a transformer-based architecture to process the request.

The request may comprises columnar data and he proxy may apply a regression model or time series-based analysis to process the request.

The method may further comprise: retrieving, by the proxy prior to routing the request, account credentials for the public cloud, and the account credentials may be used to access the public cloud when routing the request to the machine learning model.

The method may further comprise: whitelisting a connection between an egress address of the private cloud and an address range of the public cloud.

The request may be routed to the public cloud endpoint by the proxy as an application programming interface (API) call, and the results of the forecasting task may be received at the private cloud endpoint as a result of the API call.

The method may further comprise: wrapping, by the proxy, prediction code of the machine learning model under an API route.

The method may further comprise: spinning up, by the proxy prior to routing the request, the machine learning model on the public cloud.

The method may further comprise: mapping an IP address of the public cloud to an IP address of the proxy, and the IP address of the public cloud may be hidden at the private cloud endpoint by showing the IP address of the proxy at the private cloud endpoint.

The private cloud endpoint may mirror the public cloud endpoint of the public cloud.

The request may be received from a scheduler configured to perform the forecasting task at regular intervals.

The method may further comprise: training at least one machine learning model into the plurality of trained machine learning models using data stored on the public cloud.

The request may comprise data stored on the private cloud.

According to another aspect, there is provided a system for applying machine learning in a hybrid cloud computing environment, the system comprising: at least one communications interface; and at least one processor communicatively coupled to the network interface and configured to perform any of the foregoing methods or suitable combinations thereof, wherein the at least one processor communicates with the public cloud using the at least one network interface.

The at least one communications interface may be for accessing a private cloud and the at least one processor communicatively coupled to the network interface may be coupled to the network interface and the private cloud.

The request may be received at a private cloud endpoint of the private cloud via the at least one communications interface.

The results of the forecasting task output by the machine learning model may be displayed at the at least one communications interface.

According to another aspect, there is provided a non-transitory computer readable medium having stored thereon computer program code that is executable by a processor and that, when executed by the processor, causes the processor to perform any of the foregoing methods or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIGS. 1 to 3 are block diagrams of a system for hybrid cloud machine learning, according to example embodiments.

FIG. 4 depicts graphs representing forecasting predictions made by the system for hybrid cloud machine learning of FIGS. 1 to 3, according to example embodiments.

FIG. 5 depicts a computer system that may be used to implement the system for hybrid cloud machine learning of FIGS. 1 to 3, according to an example embodiment.

FIG. 6 depicts a method for applying machine learning in a hybrid cloud environment using the system of FIGS. 1 to 3, according to an example embodiment.

### DETAILED DESCRIPTION

The embodiments described herein are directed at methods, systems, and techniques for applying machine learning in a hybrid cloud computing environment. More particularly, the embodiments described herein are directed at using a hybrid cloud computing environment (i.e., a combination of at least one public cloud and at least one private cloud) to perform at least one forecasting task at inference using a machine learning model. More generally, the forecasting task(s) performed at inference may, in at least some embodiments, be any suitable sequential forecasting task; i.e., a task to predict future value(s) or event(s) in a time-ordered sequence. Example sequential forecasting tasks comprise anomaly detection and/or volume prediction. Other example sequential forecasting tasks comprise weather forecasting based on past weather observations over time and product recommendation for a person based on the person's past product purchases.

Specifically, the present disclosure relates to systems and methods which can achieve noise reduction and higher transparency in volume prediction, anomaly detection, and event correlation with repeatable patterns for data ingestion, deployment, and integration. The disclosed systems and methods can comprise use of API automation for data preprocessing and hyperparameter tuning of machine learning models, thus providing the users with well-performing forecasting models. Example applications of the disclosed systems and methods may include forecasting of any one or more of operational/web traffic, stock pricing, supply/demand/sales, climate & weather, economics, or demographics.

According to a broad aspect, the present system and method may be a forecasting and anomaly detection service. For example, application logs may be continually generated for a computing service, platform, or environment according to the usage and operations thereof. Based on forecasts of (data) volume (e.g., through tracked data) and processing times from application logs, anomalies on these quantities can be detected and sent as alerts to system administrators. This leverages machine learning to understand data context, to check variables, and to detect anomalies, in a manner not previously done by individuals.

Specifically, products, services, and applications, which may be accessible and implemented through the use of a private cloud of an organization, may be required to be available at all times. Notably, the operations (e.g., in the private cloud) running those applications need to be in an “operational resiliency” state. Operational or application resiliency (e.g., maintaining a standard and acceptable level of performance under all operation conditions) has a heavy dependency on data availability, and can be an important consideration in ensuring the products, services, and applications are available, when (and where) the user wants. Therefore, in order to accommodate user operations, “operational resiliency” must be maintained, where the volume of data can be a key factor in maintaining such a resiliency. Accordingly, it can be beneficial to move away from managing/tuning the operations of the products, services, and applications by “reacting” to the volume of data but rather to predict or estimate when or under what conditions the volume of data will increase or decrease, thus achieving predictive “operational states” that actively accommodate the changes in operational burden from the changes in data volume before the changes occur.

The present disclosure provides systems and methods of applying machine learning in a hybrid cloud computing environment to enhance data security, improve efficiencies in data processing and handling, as well as to prevent Internet Protocol (“IP”) conflicts/congestion by processing a request from/at a private cloud for performing a forecasting task with a proxy. The proxy can analyze/process the request to identify/determine a pre-trained machine learning model on a public cloud that is appropriate for processing the request (e.g., performing the forecasting), for example based on at least one parameter of the model and/or the request. The proxy can route the request to the public endpoint of the public cloud hosting the determined machine learning model to process the request and to return the output of the machine learning model to the private cloud. In some implementations, the request may be processed as an application programming interface (“API”) call to the public cloud (e.g., the machine learning model) such that the results are returned to the private cloud as the response to the API call. Although the disclosed systems and methods are generally implemented for performing forecasting tasks, it should be noted that the present disclosure may also be applicable for other uses of machine learning models in a hybrid cloud computing environment.

In accordance with the present disclosure, the disclosed systems and methods may comprise at least one machine learning model and API service (e.g., through the use of a proxy) for anomaly detection and volume prediction (e.g., in/for data) or use thereof. The machine learning model and API service may be implemented and accessed through the private cloud, and thus can be elastic and scalable. Particularly, through the use of the hybrid computing environment, users can access the API service and accordingly the public cloud without cloud onboarding. A technical advantage/effect of the hybrid cloud implementation can be efficiency improvements from eliminating the need for integrating the public cloud (e.g., operations performed thereon) into the private cloud. Similarly, operational requirements and strain (e.g., storage and processing power) on the private cloud can be reduced through the use of the public cloud without local (e.g., private cloud) integration, which can also result in a decrease of response time for operations such as event forecasting. Notably, the machine learning models as well as services/operations dependent thereon can be deployed at a faster rate, as the resistance of having to onboard to the private cloud each of machine learning models (e.g., for specific forecasting tasks) is removed. Additionally, each user accessing the public cloud may be required to authenticate with the public cloud individually (e.g., with unique credentials and integration rules/setup). In contrast, the present disclosure can provide centralized and seamless integration between the private cloud and public cloud (and services/operations thereon), for example, via a (multi-cloud) proxy.

Furthermore, it is possible to eliminate issues with regard to IP range complexity and collision (e.g., as present in conventional multi-cloud platforms/services), for example by utilizing the API service for bridging the private and public clouds. In particular, IP range clashes can be avoided despite the required communications/connections between the private cloud and the public cloud (e.g., accessing the public cloud from the private cloud). In brief, if the private cloud uses an IP address range that is also used by resources in the public cloud, such as a virtual machine or service, there can be a conflict when trying to establish connections between the two. When two networks have overlapping IP ranges, it becomes challenging for routers and firewalls to determine the correct path for data packets. This can result in failed connections or data being sent to the wrong destination. Implications of the IP range clash can result in users or applications in the private cloud being unable to reach resources in the public cloud, leading to downtime or degraded service as well as increased security risk of misconfigured firewalls and routing tables due to IP conflicts that can expose systems to security vulnerabilities. Conventionally, complex network management may be required to mitigate these issues, for example by implementing workarounds, such as virtual private networks (“VPNs”) or Network Address Translation (“NAT”), to manage the conflict, increasing operational overhead. As such, by eliminating IP range clashes, the present disclosure can also provide increased security and system performance.

Another advantage of at least some embodiments of the disclosed systems and methods is enhanced cyber security and privacy, particularly for the access and transfer of (sensitive) data as well as during interactions with (private) system components and services. In particular, it is possible to leverage the usage of public cloud resources (e.g., computation, processing power, platforms, and services) through the private cloud (e.g., a layer thereof configured to interact, control and manage use of the public cloud resources) via the hybrid computing environment. Accordingly, security measures, policies, and standards required by and maintained for the private cloud (e.g., for any actions that utilize the private cloud) can also be “applied” to the public cloud (e.g., usage thereof) when interacted through the hybrid computing environment using the private cloud (e.g., by using a proxy, as described herein). For example, the integrity of the information/data exchanged between the private and public cloud can be ensured by maintaining the security measures, policies, and standards.

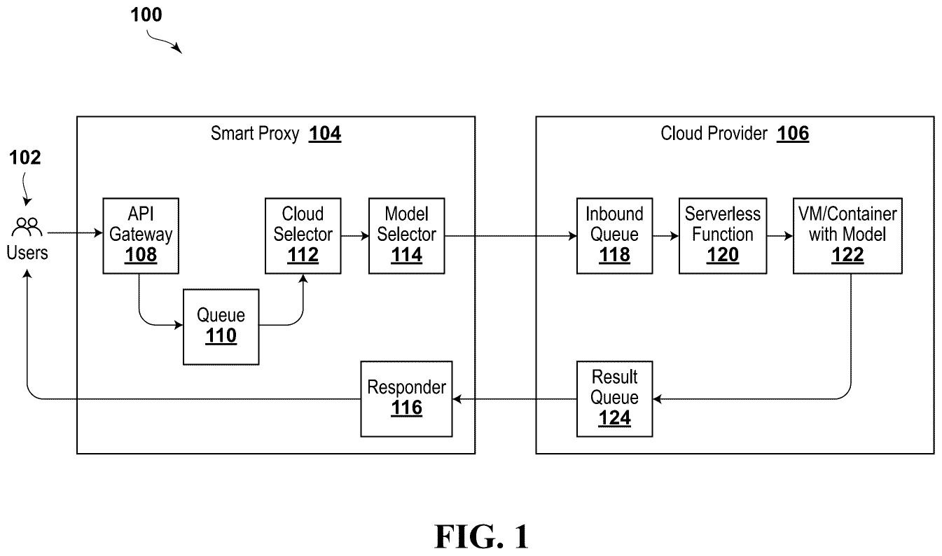

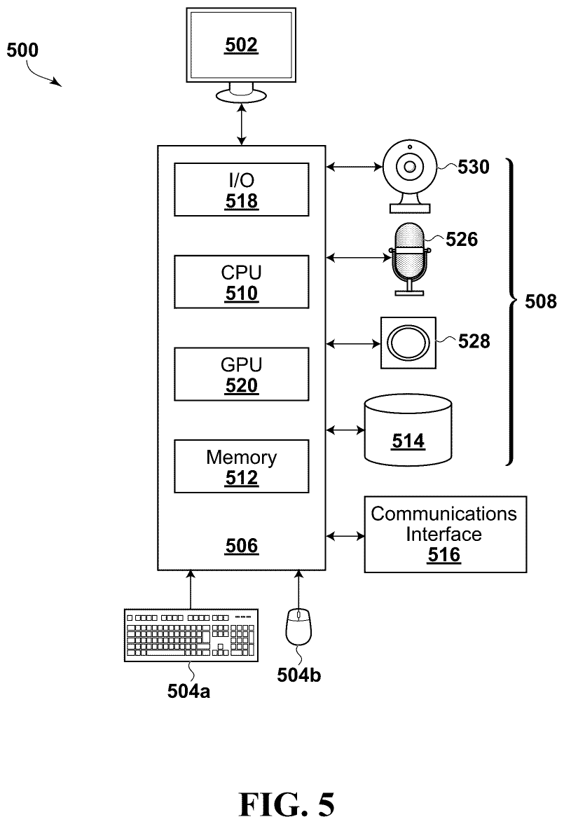

More particularly, FIG. 1 depicts an example system 100 for applying machine learning in a hybrid cloud computing environment, according to an example embodiment. A user 102 interacts with the system 100, which generally comprises a smart proxy 104 that is communicative with a public cloud 106. The proxy 104 runs in a private cloud environment. As used herein, a “private cloud” is a cloud computing environment comprising at least one server, which may comprise a computer as described in FIG. 5 below, operated only for a single organization. A private cloud may be implemented using on-premises servers and be deployed exclusively to persons on the same local area network as the private cloud, for example. In particular, a number of policies and security measures controlled by that organization may be implemented within the private cloud (e.g., for data stored/processed thereon). As described with respect to FIGS. 1-3, the private cloud may comprise or is implemented on OpenShift™ Container Platform. In contrast, as used herein a “public cloud” is a cloud computing environment comprising at least server, which may comprise a computer as described in FIG. 5 below, operated for the benefit of multiple customers. A public cloud is typically not hosted on-premises with the customers that use it, and access to the public cloud is typically via a wide area network such as the Internet. The data stored on the public cloud by different customers is protected by access credentials respectively held by those different customers.

In FIG. 1, the user 102 may be an employee of the organization that maintains the private cloud on which the proxy 104 runs. The user 102 may make a request to perform at least one of volume forecasting or anomaly detection using a trained machine learning model resident in the public cloud 106; as described further below, in the depicted embodiment the machine learning model is contained within a virtual machine 122 and/or a container running in the public cloud 106 (e.g., hosted or implemented on the public cloud 106). The user may input the request and interact with the proxy 104 from the private cloud, in particular a communication interface communicatively coupled thereto, for example, through a device such as a computer or mobile device. The user's 102 request is input to using an application programming interface (“API”) gateway 108, which routes the request to an appropriate API. That API acts as a private cloud endpoint. In particular, the proxy 104 may be callable by the user 102 from the private cloud endpoint.

Accordingly, the private cloud (e.g., requests therefrom) can interface with the public cloud (e.g., the machine learning model implemented thereon) without having to implement/onboard the machine learning model resident on the public cloud 106 to the private cloud. That is, although the public cloud 106 is leveraged, exposure of the data or request publicly (i.e. via the public cloud 106) can be avoided without needing to deploy to the private cloud environment. By utilizing the proxy 104, connections to and from the public cloud 106 can be managed automatically therewith. Further, as public clouds are generally more elastic, cost-efficient, and scalable, it is possible to perform more affordable and parallelizable processes (e.g., involving the machine learning model) thereon.

In accordance with the present disclosure, all users that are approved/authorized to perform operations on the private cloud may utilize the proxy 104 to interface with the public cloud 106 without requiring additional clearance or permissions (e.g., registering/authorizing additional credentials that for access the public cloud 106). For example, it is assumed that users authorized to operate within the private cloud having more sensitive data (e.g., users and data from the organization) should also have authorization to operate the public cloud 106, which generally contains/processes less sensitive data. Therefore, requests/tasks involving the public cloud 106 can be processed more efficiently and effectively by eliminating unnecessary authorization, authentication, and credentials. For example, only the proxy 104 is required to have the credentials for accessing/operating the public cloud 106.

The user's 102 request is routed to an input queue 110 with other requests from the same or other users 102. On exiting the queue 110, the proxy 104 selects an appropriate public cloud using a cloud selector 112, and subsequently selects an appropriate machine learning model using a model selector 114. In particular, the machine learning model may be a (pre-)trained machine learning model, specifically a model that is trained and tuned to perform a forecasting task, more specifically a particular type of forecasting task. In some embodiments, a plurality of machine learning models may be available for selection.

The cloud selector 112 comprises a service that checks the health of the endpoints resident in various public clouds 106. If the health check shows that a particular public cloud 106 is online and consequently able to process the request, the cloud selector 112 may select that public cloud 106 to receive the request. If multiple public clouds 106 are healthy and available, the proxy 104 may select the public cloud 106 that receives the request in any suitable manner, such as randomly or in a round robin fashion taking into account the other requests the proxy 104 handles. The health check may be performed using a suitable microservice, for example; additionally or alternatively, the public cloud 106 that is selected may be selected based on time of day and actual/expected associated load, for example, to ensure highest chance of the public cloud's 106 availability and performance.

In order to select the appropriate machine learning model, the proxy 104 interprets the user's 102 request prior to routing it. For example, when the request is textual, such as in the form of an API call with a string parameter, the proxy 104 may apply a machine learning-based approach, such as a recurrent neural network or a transformer-based architecture, to perform natural language processing to process the request. When the request comprises columnar data, such as an API call with a spreadsheet or .CSV file as a parameter, the proxy 104 may recognize that columnar data and accordingly process the request with a regression model or time series-based analysis. For example, the proxy 104 may apply a transformer to determine whether volume forecasting or anomaly detection is to be performed, and to assess factors such as speed, accuracy, and cost to determine which machine learning model to use.

The proxy 104 may first select an appropriate public cloud 106, as described above, then select an appropriate machine learning model on the public cloud 106. That is, the selected public cloud 106 may have implemented thereon a plurality of machine learning models available for selection (e.g., some or all of the machine learning models for processing the request), from which a suitable model is chosen. Alternatively, the proxy 104 may first select an appropriate machine learning model from all of the machine learning models available for processing the request and subsequently select an appropriate public cloud 106, for example a public cloud comprising the selected machine learning model. In some embodiments, the same or similar machine learning models may be available for selection on multiple public clouds. In such cases, the proxy 104 may select any one of the public clouds, for example using the cloud selector 112, as described above.

Specifically, the proxy 104 may make the selection of the machine learning model based on one or more parameters of the request and/or the machine learning model(s). According to an embodiment in which speed, accuracy, and cost are considered in a binary fashion, the proxy 104 may decide which of eight trained machine learning models to use as follows:

TABLE 1
Model Selection Table

| Model | | | | |
|---|---|---|---|---|
| No. | Characteristics | Speed | Accuracy | Cost |
| 1 | Fast, low/unbounded accuracy, unbounded | 1 | 0 | 0 |
| | cost | | | |
| 2 | Unbounded speed, high accuracy, unbounded | 0 | 1 | 0 |
| | cost | | | |
| 3 | Fast, low/unbounded accuracy, low cost | 1 | 0 | 1 |
| 4 | Unbounded speed, high accuracy, low cost | 0 | 1 | 1 |
| 5 | Fast, high accuracy, low cost | 1 | 1 | 1 |
| 6 | Unbounded speed, unbounded accuracy, | 0 | 0 | 0 |
| | unbounded cost | | | |
| 7 | Fast, high accuracy, unbounded cost | 1 | 1 | 0 |
| 8 | Unbounded speed, unbounded accuracy, low | 0 | 0 | 1 |
| | cost | | | |

where a parameter is denoted using “1” when it is fast, accurate, or low cost, as appropriate, and denoted using “0” otherwise.

The proxy 104 may select one of the eight models in Table 1 based on the speed, accuracy, and cost desired by the user 102 or required of the task, where the speed, accuracy, and cost constraints are parameters of the request and model for consideration. That is, the speed, accuracy, and cost constraints may both refer to what is required by the request (e.g., how quickly, accurately, and costly the performance of the task should be) and the properties of the trained machine learning model (e.g., how quickly, accurately, and at what cost the trained machine learning model can perform the task). The user 102 may expressly specify the factors relevant for model selection, such as speed/accuracy/cost; alternatively, the proxy 104 may make that determination itself based on the nature of the data to be processed. For example, if the data to be processed is a small, tabular dataset, the proxy 104 may automatically select a low cost and fast model, such as model no. 3 in Table 1. The proxy 104 may return model selection with the API response, and the user 102 may in response to that API response override the proxy's 104 default model choice (e.g., in the foregoing example, the user 102 may manually select model no. 4 instead of model no. 3).

While Table 1 shows the factors of speed, accuracy, and cost being assigned binary values, in at least some other embodiments the proxy 104 may use non-binary values (e.g., fractions or an integer ranking from 1-10) to allow more trained models to be compared to each other. In particular, the selection can be based on a ranking of the factors (e.g., faster vs. slower) and/or how well the factors matches the requirements of the request (e.g., how closely the speed matches the desired processing speed), where each factor can have more specific ranking values, rather than just matching the requirements of the request to the factors of the model in a binary fashion. For example, fractional rankings for speed, accuracy, and cost can be used to allow multiple models with shared characteristics to be compared to each other. In such an example, multiple models may be fast, highly accurate, and be low cost, but to different degrees. Consequently, in respect of speed, accuracy, and low cost, one model may be ranked {1,1,1}, another may be ranked {1.5,0.5,0.25}, and a third may be ranked {0.25,1.5,0.5}, thus allowing for more flexibility in model selection and allowing more models to be considered for selection.

Advantageously, while conventional systems require the user to manually determine an appropriate service among the many cloud services for use, the proxy 104 (e.g., in the form of an API call) can use data and description provided by users to infer and provision the right cloud service (e.g., where the prospective models are implemented) for the use case at hand without much disruption.

Following model selection, the proxy 104 may spin up the virtual machine 122 in which the selected model runs (e.g., through model initialization, preparation, configuration, and tuning of the model). Spinning up a model following model selection results in more efficient use of computational resources relative to embodiments in which all possible models are concurrently running at the cost of a start-up cost in the form of the time required to spin up each model. In some example embodiments and as discussed further below, the model may be small enough to be hosted entirely in a serverless architecture, eliminating the start-up cost. The spin-up of the model may be based on the request (e.g., the data or type thereof to be processed by the model).

Accordingly, by being able to automatically select and provision (e.g., spin up) the appropriate model and public cloud, the proxy 104 can save the time the user 102 would have otherwise spent on having to read the documentation of each public cloud and/or model (e.g., for comparison and selection) and learning how to use them individually. That is, the user 102 may not need any technical knowledge at all to perform the forecasting task optimally.

For the purposes of volume prediction or anomaly detection, the trained machine learning model in the virtual machine 122 is based on a transformer architecture or a temporal convolutional network architecture. Anomaly detection may be performed based on the results of the volume forecasting. The volume forecasting in at least some example embodiments returns one or more quantitative volume predictions and statistical metrics for one or more future time-steps, respectively. For example, the volume forecasting may forecast a volume of n operations (e.g., 9,000) (the quantitative volume prediction) with a standard deviation of a (e.g., 100) (the statistical metric) for the following day. When the following day arrives, anomaly detection may be performed by comparing the actual quantitative volume with the predicted volume (e.g., 8,500) to the predicted volume in view of the statistical metric. In the example where the forecasted volume is 9,000 with a standard deviation of 100, an actual observed volume of 8,500 is 5 standard deviations outside the prediction and may be used to flag the actual observed volume as an anomaly. In particular, volume prediction may be used to predict when an increase/decrease in the volume of data flow can occur or a data flow volume at specific time(s) as to better manage operations and resources on the private cloud.

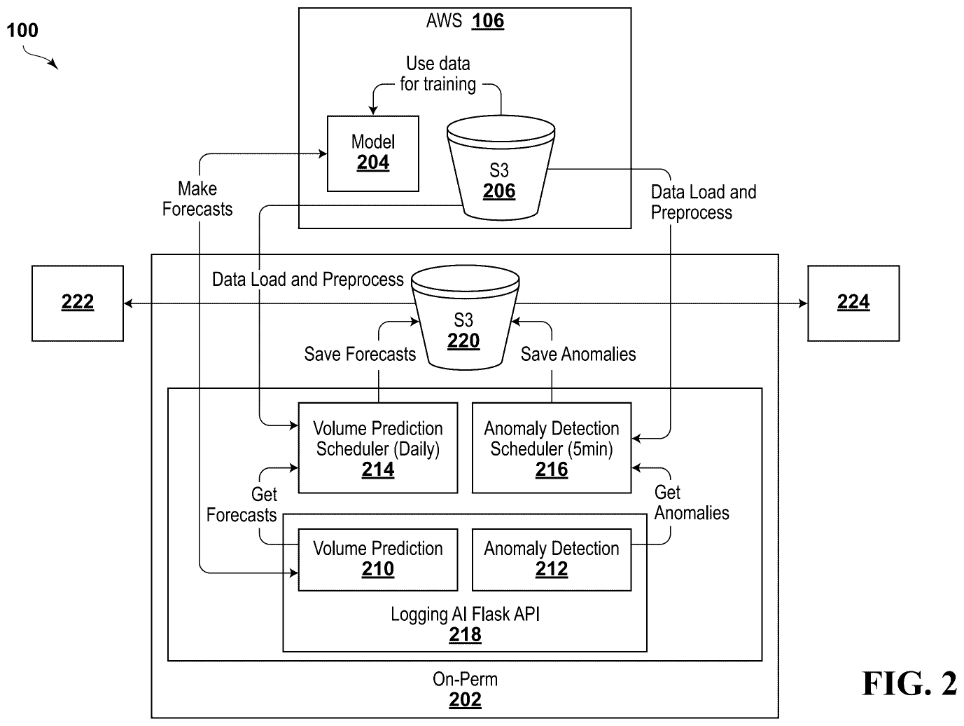

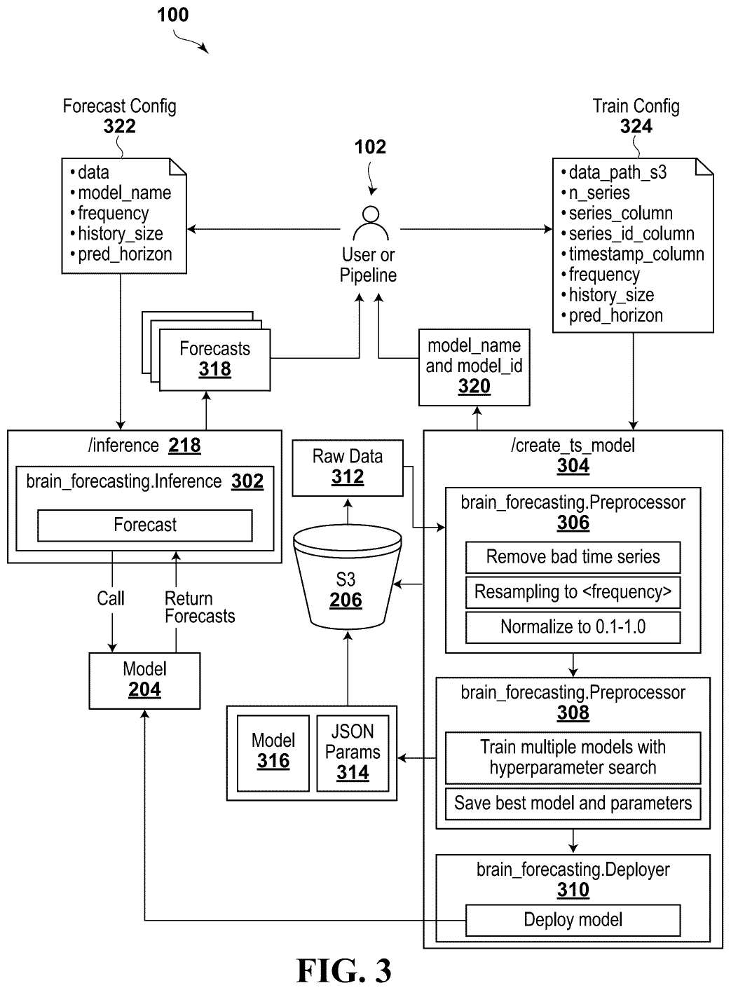

Prior to routing the request to the public cloud 106, the proxy 104 retrieves account credentials for the public cloud 106 from a credentials vault to permit access to the public cloud 106 and consequently to permit the request to be routed to the virtual machine 122. As discussed further below in respect of FIGS. 2 and 3, the public cloud 106 may comprise an AWS™ public cloud, in which case the access credentials are AWS™ access credentials.

To address security-related network restrictions (e.g., firewalls), the proxy 104 also whitelists a connection between the IP address range of the public cloud 106 and the egress IP address of the private cloud from which the request is sent. Additionally, the proxy 104 wraps prediction code of the trained machine learning model under an API route to permit the output of the machine learning model to be returned as a result of the API call (e.g., API response). The proxy 104 accesses a list of trusted, whitelisted IP addresses to ensure that only trusted IP addresses are communicated with. The underlying IP address of the public cloud 106 is hidden from the user 102 (e.g., at the endpoint of the private cloud) and appears to the user 102 as the proxy's 104 IP address, thereby making the public cloud's 106 IP address invisible to the user 102. For example, if the public cloud's 106 IP address is 1.1.1.2, the proxy's 104 IP address may be 2.2.2.3/api_endpoint_1234, and this API endpoint may be mapped by the proxy 104 to 1.1.1.2. API endpoints are in at least some example embodiments globally unique to prevent collision and allow for traceability. The private cloud endpoint (the API interface in an example in which the request is in the form of an API call) accordingly mirrors the public cloud endpoint (the virtual machine 122 in FIG. 1).

It should also be noted that by routing the request from the private cloud using the proxy 104, it is possible to limit the number of IP addresses that is assigned (e.g., for interfacing the private cloud with the public cloud 106). In particular, only one IP address may be required (e.g., by the private cloud for interfacing with the public cloud 106), which is that of the proxy 104. As such, the private cloud may limit the management of connections and IP addresses to that of the proxy 104 (e.g., for policies, privacy settings, and firewall settings), which can be indirectly managed and applied in the same manner through the use of or by the proxy 104. Accordingly, the private cloud may not be required to assign an IP address for each public cloud or machine learning model that it is interfaced with and may be required to assign an IP address for each forecasting task (e.g., each use of a particular machine learning model). It should also be noted that by reducing the number of assigned IP addresses and whitelisting the connection between the IP address range of the public cloud 106 and the egress IP address of the private cloud, IP clashes may be avoided.

By performing the above actions, the proxy 104 routes the user's 102 request to the trained machine learning model running in the virtual machine 122 on the public cloud 106. The proxy 104 can route the request from the private cloud endpoint to a public cloud endpoint of the public cloud 106 for processing by the machine learning model. More particularly, the request is received at the public cloud 106 by an inbound queue 118, and is forwarded to a serverless functionality module 120 that enables serverless implementation of relatively small machine learning models, as described above. Further, the trained machine learning model may be deployed at the public cloud endpoint for inference (e.g., performing the forecasting task of the request). While FIG. 1 shows a serverless implementation by way of the serverless functionality module 120, in at least some other embodiments the implementation is not serverless and may instead be server-based. The request is then sent to the virtual machine 122 with the trained machine learning model, where the volume prediction or anomaly detection is performed, such as by using automated machine learning (AutoML) as described above. The result is sent to a result queue 124, which sends the result back to a responder 116 in the private cloud. The responder 116 returns the result to the user 102 as a response to the API call by virtue of the machine learning model's prediction code being wrapped under the API route.

In some embodiments, the processes performed by the proxy 104 as described above may be implemented using a direct acrylic graph on a platform configured to perform the extract, transform, and load (ETL) process with respect to above described process.

Referring now to FIG. 2, there is shown another block diagram of the system 100 for applying machine learning in a hybrid cloud computing environment. The block diagram of FIG. 2 expressly shows the on-premises private cloud 202 from which the API 218 accessed via the API gateway 108 is called, and the public cloud 106. The public cloud 106 in FIG. 2 is an AWS™ public cloud, and comprises cloud storage 206 in the form of S3™ storage, or another suitable database, and a machine learning model endpoint 204 providing access to a machine learning model implemented using SageMaker™. The machine learning model can read to and write from the storage 206, and accordingly retrieve training data stored in the storage 206 for training purposes.

As described in respect of FIG. 1 above, the API 218 is able to be called to perform volume prediction 210 and anomaly detection 212. The API is implemented using an OpenShift™ cluster 208. Also implemented using the cluster 208 are a volume prediction scheduler 214 configured to perform volume prediction (e.g., volume prediction 210) daily, and an anomaly detection scheduler 216 configured to perform anomaly detection (e.g., anomaly detection 212) every five minutes. Although FIG. 2 depicts the volume prediction scheduler 214 as being configured to perform volume prediction daily, and the anomaly detection scheduler 216 being configured to perform anomaly detection every five minutes, other intervals for performing volume prediction and anomaly detection are also possible. For example, a user can set and/or adjust the interval at which the volume prediction scheduler 214 and the anomaly detection scheduler 216 perform their respective forecasting tasks (e.g., volume prediction 210 and anomaly detection 212). Each of the volume prediction scheduler 214 and the anomaly detection scheduler 216 may be configured to perform a plurality of different forecasting tasks, each of which may have a respective scheduled interval. Each of the volume prediction scheduler 214 and anomaly detection scheduler 216 loads log data comprising historical data of length n from the cloud storage 206, where n is the context length that is considered in order to make a prediction, and performs appropriately preprocessing on that data prior to inputting it to the appropriate model (e.g., by interfacing with the model 204 for request processing). That is, data of the organization, which can be used for volume prediction and anomaly detection, may be stored on the public cloud 106 as the volume of data may be large and more cost effective to store on the public cloud 106. The schedulers 214, 216 operate to limit the number of times the cloud storage 206 is accessed. The private cloud 202 also comprises, outside of the cluster 208, on-premises storage 220 also in the form of S3™ storage. The schedulers 214, 216 load the historical data as well as the saved predictions by both volume prediction 210 and anomaly detection 212 models into the same on-premises storage 220.

At inference, the schedulers 214, 216 can call the proxy 104 to perform the forecasting task by interfacing with the model 204. In particular, the API 218 may call the schedulers 214, 216 (e.g., at specific intervals, as described above), to perform volume prediction 210 or anomaly detection 212. When performing volume prediction 210 or anomaly detection 212, the API 218 obtains historical log data from the on-premises storage 220 (e.g., a database). Volume prediction 210 uses the historical log data to predict volume at one or more future time steps; consequently, the volume prediction scheduler 214 uses the historical data of length n obtained from the cloud storage 206 for predictive purposes, for example using the proxy 104 to interface with the model 204 as described with respect to FIG. 1. For anomaly detection 212, the API 218 accesses a volume forecast resulting from volume prediction 210 as saved on the on-premises storage 220 for a future time step as well as the observed value for that time step that is also saved on the on-premises storage 220, and determines whether or not that observed value is anomalous. Anomaly detection 212 accordingly waits at least one time-step to observe the actual value at a future time-step for which volume prediction 210 made a prediction. As described above, the API 218 may also retrieve data from the cloud storage 206 for performing volume prediction 210 or anomaly detection 212. Furthermore, results of the volume prediction 210 and/or anomaly detection 212 can be saved in the on-premises storage 220 and/or the cloud storage 206.

The framework depicted in FIG. 2 routes private OpenShift™ cluster 208 traffic to the public SageMaker™-implemented model, and permits the hybrid cloud computing pipeline to be called via an OpenShift™ cluster 208 endpoint (i.e., in FIG. 2, the API 218). It should be noted that although FIG. 2 depicts schedulers 214, 216 retrieving data from cloud storage 206 for use in performing the forecasting task (e.g., volume prediction 210 and anomaly detection 212), retrieval from on-premises storage 220 is possible as well. Additionally, data stored in the on-premises storage 220 and/or the cloud storage 206 (e.g., data used for and results of volume prediction 210 and anomaly detection 212) may be provided to data platforms 222, 224 for processing and analysis (e.g., with regard to the volume of data, anomalies in the organizational data, and machine learning model performance). For example, data platforms 222, 224 may be third-party data platforms such as Elasticsearch™ and PagerDuty™.

Referring now to FIG. 3, there is shown another block diagram of the system 100 for applying machine learning in a hybrid cloud computing environment. As in FIGS. 1 and 2, the user 102 may call the API 218 (e.g., through the proxy 104) to perform forecasting task(s) such as obtaining volume prediction (i.e., time-series prediction) forecasts or detecting anomalies via an inference library 302. In response to calling the API 218, the model endpoint 204 is instructed to perform the forecasting task, as described above, and it returns forecasts 318to the API 218, which in turn returns them to the user 102. FIG. 3 also shows the configuration parameters 322 that the user 102 may pass to the API 218 when calling it: the data itself or a path to the data; the name of the machine learning model to use, which may be input by the user 102 or automatically selected by the proxy 104; sampling frequency of the data (e.g., by the schedulers 214, 216); history size of log data to be considered for prediction purposes; and the prediction horizon. The parameters 322 may be stored in and/or retrieved from the on-premises storage 220 and/or the cloud storage 206.

FIG. 3 also depicts how the machine learning model is trained. Namely, the user 102 calls a training API 304 and passes certain training parameters 324 to the API 304 as part of this call: the path to the cloud storage 206 where the training data in the form of a time series dataset is stored (or to the on-premises storage 220 if training data is stored therein); the number of elements in the training data series; series_column, which stores the time-series of data and with each row corresponding to a different time-step; series_id_column, which stores every ID associated with a time-step; timestamp_column, which stores the timestamp (e.g., exact date/time) associated with each time-step; resampling frequency, which is a frequency parameter used to resample or change the raw data into the appropriate sampling frequency (e.g., from seconds to minutes/hours/days); history size of log data to be considered for prediction purposes; and the prediction horizon. The training API 304 may comprise a part of the private cloud or a part of the public cloud 106. In some embodiments, the training API 304 may be implemented as or comprise a part of the proxy 104. Alternatively, the training API 304 may be configured to interact with the proxy 104. The training parameters 324 may be input by the user 102, automatically selected by the proxy 104, or determined using third-party programs/platforms (e.g., the cloud platform hosting/operating the machine learning model). The training parameters 324 may be stored in and/or retrieved from the on-premises storage 220 and/or the cloud storage 206.

The training API itself comprises a preprocessor library 306, a trainer library 308, and a deployer library 310. The preprocessor library 306 may be implemented using the pandas™ library, and retrieve the raw training data 312 from the cloud storage 206 and/or on-premises storage 220, as specified in the training parameters 324. The preprocessor library 306 can pre-process the data, for example to remove bad time series data, resample the data to the frequency specified in the training parameters 324, and normalize the data to 0.1-1.0 (or other values as needed). The data, thus preprocessed, is sent to the trainer library 308, which may be implemented using SageMaker Autopilot™, Darts™ by Python™, and/or Optuna™. The trainer library 308 may train the available machine learning models from multiple hyperparameter training runs using the hyperparameters from various sources or set by the user, such as from/with an Optuna™ library, and save the best model 316 and its associated parameters 314, or multiple potentially suitable models 316 and their respective parameters 314 (e.g., saved as JSON files), for example in the cloud storage 206. Once trained, the model 316 is deployed by the deployer library 310 and made available to the inference library 302 on the public cloud 106 via the model endpoint 204. The model 316 may be continuously trained or updated for deployment such that the proxy 104 can process requests therewith. In some embodiments, the proxy 104 (e.g., the training API 304) can train/deploy a new model after receiving a request if there is no suitable model for processing the request. The model 316 may be assigned an identifier (ID) and/or a name for identification (320), which can be returned to the user 102.

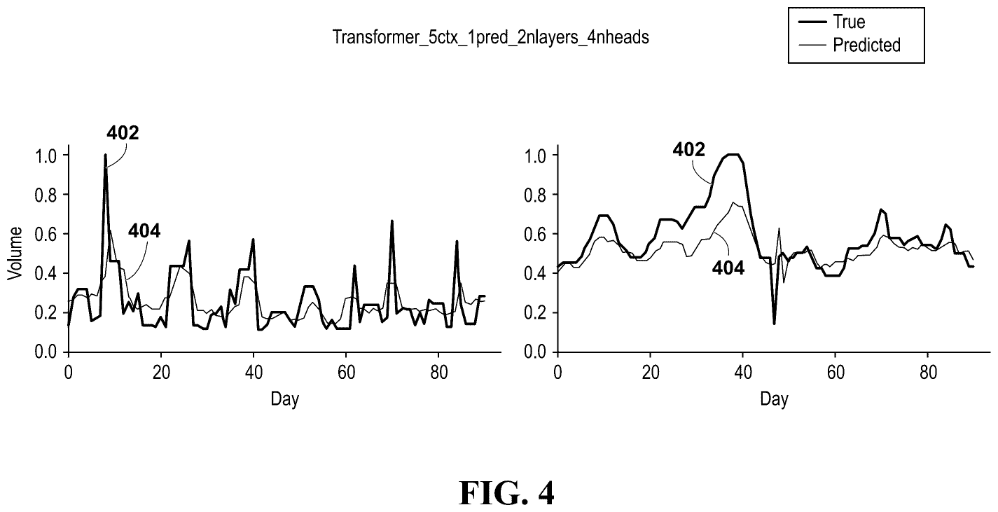

FIG. 4 depicts graphs representing forecasting predictions made by the system 100. Each of the graphs shows volume predictions by day for each of several different files representing different data. The graphs contrast the actual vs. predicted volumes respectively as the curves labeled 402 vs. 404. The trained machine learning model 316 used to generate these predictions was a transformer-based architecture.

An example computer system in respect of which the system 100 described may be implemented is presented as a block diagram in FIG. 5. The example computer system is denoted generally by reference numeral 500 and includes a display 502, input devices in the form of keyboard 504a and pointing device 504b, computer 506 and external devices 508. While pointing device 504b is depicted as a mouse, it will be appreciated that other types of pointing device, or a touch screen, may also be used.

The computer 506 may contain one or more processors or microprocessors, such as a central processing unit (CPU) 510. The CPU 510 performs arithmetic calculations and control functions to execute software stored in a non-transitory internal memory 512, preferably random access memory (RAM) and/or read only memory (ROM), and possibly additional memory 514. The additional memory 514 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 514 may be physically internal to the computer 506, or external as shown in FIG. 5, or both.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation of a processing unit may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal and/or additional memory 514 for execution by the one or more processors or microprocessors to effect neural network pre-training, training, or use of a trained network for inference.

The computer system 500 may also include other similar means for allowing computer programs or other instructions to be loaded. Such means can include, for example, a communications interface 516 which allows software and data to be transferred between the computer system 500 and external systems and networks. Examples of communications interface 516 can include a modem, a network interface such as an Ethernet card, a wireless communication interface, or a serial or parallel communications port. Software and data transferred via communications interface 516 are in the form of signals which can be electronic, acoustic, electromagnetic, optical or other signals capable of being received by communications interface 516. Multiple interfaces, of course, can be provided on a single computer system 500.

Input and output to and from the computer 506 is administered by the input/output (I/O) interface 518. This I/O interface 518 administers control of the display 502, keyboard 1104a, external devices 508 and other such components of the computer system 500. The computer 506 also includes a graphical processing unit (GPU) 520. The latter may also be used for computational purposes as an adjunct to, or instead of, the (CPU) 510, for mathematical calculations.

The external devices 508 include a microphone 526, a speaker 528 and a camera 1130. Although shown as external devices, they may alternatively be built in as part of the hardware of the computer system 500.

The various components of the computer system 500 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

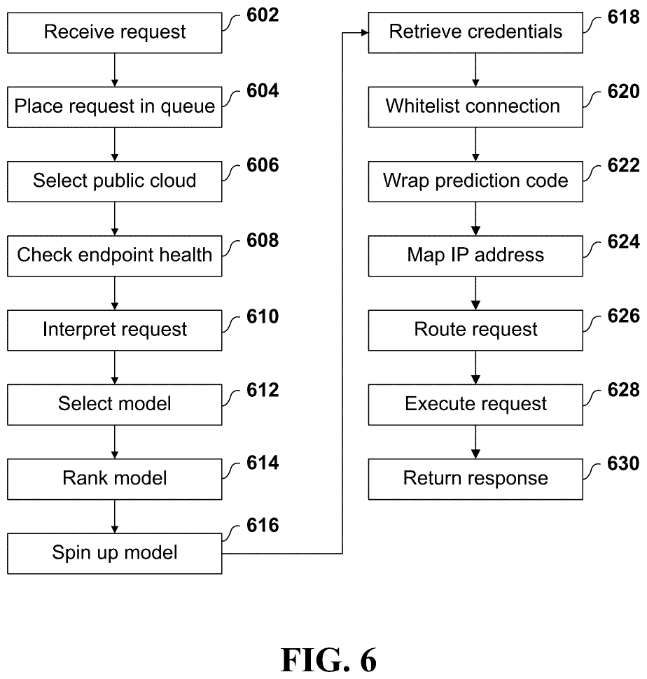

FIG. 6 depicts a method for applying machine learning in a hybrid cloud environment using the system of FIGS. 1 to 3, according to an example embodiment. At 602, a request to perform a forecasting task is received at the system, for example from the user 102 at the private cloud through the use of one or more communications interfaces. The request may be received and processed by the proxy 104, implemented on the private cloud. The request may be directly received by the proxy 104 or routed to an API endpoint of the proxy 104 by the API gateway 108 of the proxy 104. The API gateway 108 may function as a private cloud endpoint of the private cloud.

At 604, the request may be placed in the queue 110 for processing by the proxy 104 along with other requests for performing forecasting tasks. Upon completion of queue, the proxy 104 may select an appropriate public cloud 106 for routing the request at 606, for example using the cloud selector 112. The selection of the appropriate public cloud may be based on a variety of factors. For example, the proxy 104 can perform a health check of the (available) public clouds and the endpoints thereof at 608. The health check can be performed by the cloud selector 112 to select the public cloud 106 based on the status thereof (e.g., online/offline), ability to process the request, time of day, and actual/expected associated load. The selection of the public cloud 106 may also be based on the availability of machine learning models. For example, a particular machine learning model may be optimal for performing the forecasting task; as such, the selection of the public cloud 106 may be limited to those which host the particular machine learning model.

At 610, the proxy 104 can interpret the request. In particular, the proxy 104 may limit the selection of the machine learning model to a specific type that is better tailored to the request by interpreting the request (e.g., contents of the request). For example, when the request (e.g., forecasting task) is textual (e.g., natural language), a machine learning model having a recurrent neural network or a transformer-based architecture may be selected to better process the request. As another example, when the request comprises columnar data (e.g., comprising a spreadsheet), a machine learning model comprising a regression model or trained to perform time series-based analysis may be selected. At 612, an appropriate machine learning model is selected. Beyond the selection based on the interpretation of the request, one or more parameters of the request and/or available machine learning models may be considered. In particular, the machine learning model may be selected based on assessment of speed, accuracy, and cost, for example, by best matching the requirement(s) of the request in terms of speed, accuracy, and cost to the speed, accuracy, and cost parameters of the machine learning models available for selection. Specifically, the proxy 104 can rank the properties/parameters (e.g., speed, accuracy, and cost) of the available machine learning models for comparison against one another and the request at 614. The machine learning models may also be ranked based on how well their properties (e.g., speed, accuracy, and cost) match that of the request. In some embodiments, the user 102 and/or the proxy 104 may specify factors (e.g., speed, accuracy, and cost) relevant to processing the request as well as the importance of each factor. The models may also be ranked using non-binary values such that the properties of the machine learning models can be compared to each other for selection. At 616, the proxy may spin-up the selected model to improve allocation and use of computational resources (e.g., such that all available models are not operating at the same time and that only the selected model is utilized and active).

At 618, the proxy may retrieve access/account/authorization credentials for interfacing with the selected public cloud 106 and/or for operating the machine learning model, for example from a credential vault on the private cloud. At 620, the proxy can whitelist a connection between the IP address range of the public cloud 106 and the egress IP address of the private cloud from which the request is sent, or the range of IP addresses. The proxy 104 can also access a list of trusted, whitelisted IP addresses to ensure that only trusted IP addresses are communicated with. At 622, the proxy 104 can wrap the prediction code of the trained machine learning model under an API route (e.g., format the request as an API call) such that the output of the machine learning model to be returned as an API call response. At 624, the proxy 104 can map the IP address of the public cloud 106 (e.g., endpoint thereof) to its own IP address (e.g., endpoint thereof) such that the IP address of the public cloud 106 is not shown to the user 102 (e.g., at the private cloud or endpoint thereof) by showing the IP address of the proxy 104 instead. Moreover, the endpoint of the private cloud (e.g., the endpoint of the proxy 106) can mirror that of the public cloud endpoint.

At 626, the proxy 104 may route the request to the selected machine learning model, for example, by routing the request from the private cloud endpoint to the public cloud endpoint and the API endpoint of the selected machine learning model. In particular, the request may be received at the public cloud 106 by the inbound queue 118 before being processed by the machine learning model. At 628, the request is executed by the machine learning model at the public cloud, for example upon completion of the inbound queue. The machine learning model executes the request by performing the forecasting task as defined in the request. At 630, the results/outputs from the machine learning model are returned to the user. For example, the predicted forecasting results may be returned from the public cloud to the private cloud through the endpoints thereof by the proxy 104 (e.g., as the API call response). The results may be displayed to the user 102 at the one or more communications interface.

In some embodiments, the machine learning models available for selection may be trained prior to being made available. For example, training parameters may be sent to a training API 304 for training machine learning models on a public cloud 106. The training API 304 can retrieve training data stored on the public cloud 106 (e.g., cloud storage 206) to train the machine learning models. Once trained and tuned, the machine learning model can be deployed to the public cloud 106 and made available via the model endpoint 204. In some embodiments, the machine learning model may be trained once the request is received and processed by the proxy 104. For example, the proxy 104 may determine that there is no appropriate machine learning model for selection and subsequently train an appropriate machine learning model.

It should be noted that the above described processes does not necessarily need to be performed in the order as depicted in FIG. 6. For example, the interpretation of the request at 610 and the selection of the model at 612 may be performed before the evaluation of the endpoint health at 608. As another example, processes such as connection whitelisting at 620 and IP address mapping at 624 may be performed prior to the selection of the model at 612. Further, various processes may also be performed concurrently to other processes where possible for efficiency.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a file” or “the file” does not exclude embodiments in which multiple files are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such implementation or combination is not performed using mutually exclusive parts.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of applying machine learning in a hybrid cloud computing environment for forecasting, the method comprising:
(a) receiving, at a private cloud endpoint of a private cloud, a request to perform a forecasting task;
(b) processing the request with a proxy to determine, based on the request, a machine learning model in a public cloud suitable for the forecasting task according to one or more parameters;
(c) routing the request with the proxy to a public cloud endpoint of the public cloud for processing by the machine learning model;
(d) processing, at the public cloud, the request with the machine learning model to perform the forecasting task; and
(e) routing results of the forecasting task output by the machine learning model from the public cloud endpoint to the private cloud endpoint.

2. The method of claim 1, wherein the forecasting task is a sequential forecasting task of volume forecasting and/or anomaly detection.

3. The method of claim 2, wherein the anomaly detection is performed using a result of the volume forecasting.

4. The method of claim 1, wherein the machine learning model is based on a transformer architecture or a temporal convolutional network architecture.

5. The method of claim 1,
(a) wherein the machine learning model is one of a plurality of trained machine learning models, and
(b) wherein the one or more parameters for the determination of the machine learning model is speed, accuracy, cost constraints, or combinations thereof.

6. The method of claim 5, wherein the determination of the machine learning model suitable for the forecasting task by the proxy comprises ranking the one or more parameters of the plurality of trained machine learning models using non-binary values.

7. The method of claim 1, further comprising:
(a) determining, by the proxy prior to routing the request, which of multiple public clouds to route the request,
wherein the public cloud to which the request is routed is one of the multiple public clouds.

8. The method of claim 7, further comprising:
(a) performing, by the proxy prior to routing the request, a health check on the public cloud to which the request is routed.

9. The method of claim 1,
(a) wherein the request is textual and wherein the proxy applies a transformer-based architecture to process the request, or
(b) wherein the request comprises columnar data and wherein the proxy applies a regression model or time series-based analysis to process the request.

10. The method of claim 1, further comprising:
(a) retrieving, by the proxy prior to routing the request, account credentials for the public cloud, and
wherein the account credentials are used to access the public cloud when routing the request to the machine learning model.

11. The method of claim 1, further comprising:
(a) whitelisting a connection between an egress address of the private cloud and an address range of the public cloud.

12. The method of claim 1,
(a) wherein the request is routed to the public cloud endpoint by the proxy as an application programming interface (API) call, and
(b) wherein the results of the forecasting task are received at the private cloud endpoint as a result of the API call.

13. The method of claim 12, further comprising:
(a) wrapping, by the proxy, prediction code of the machine learning model under an API route.

14. The method of claim 1, further comprising: spinning up, by the proxy prior to routing the request, the machine learning model on the public cloud.

15. The method of claim 1, further comprising:
(a) mapping an IP address of the public cloud to an IP address of the proxy,
wherein the IP address of the public cloud is hidden at the private cloud endpoint by showing the IP address of the proxy at the private cloud endpoint.

16. The method of claim 1, wherein the private cloud endpoint mirrors the public cloud endpoint of the public cloud.

17. The method of claim 1, wherein the request is received from a scheduler configured to perform the forecasting task at regular intervals.

18. The method of claim 1, further comprising:
(a) training at least one machine learning model into the plurality of trained machine learning models using data stored on the public cloud, and
wherein the request comprises data stored on the private cloud.

19. A system for applying machine learning in a hybrid cloud computing environment for forecasting, the system comprising:
(a) at least one communications interface for accessing a private cloud; and
(b) at least one processor communicatively coupled to the network interface and the private cloud, the at least one processor configured to perform a method comprising:
(i) receiving, at a private cloud endpoint of the private cloud via the at least one communications interface, a request to perform a forecasting task;
(ii) processing the request with a proxy to determine, based on the request, a machine learning model in a public cloud suitable for the forecasting task according to one or more parameters;
(iii) routing the request with the proxy to the public cloud for processing by the machine learning model;
(iv) processing, at a public cloud endpoint of the public cloud, the request with the machine learning model to perform the forecasting task; and
(v) routing results of the forecasting task output by the machine learning model from the public cloud to the private cloud endpoint for display at the at least one communications interface.

20. At least one non-transitory computer readable medium having stored thereon computer program code that is executable by at least one processor, wherein when executed the computer program code causes the at least one processor to perform a method of applying machine learning in a hybrid cloud computing environment for forecasting, the method comprising:
(a) receiving, at a private cloud endpoint, a request to perform a forecasting task;
(b) processing the request with a proxy to determine, based on the request, a machine learning model in a public cloud suitable for the forecasting task according to one or more parameters;
(c) routing the request with the proxy to a public cloud endpoint of the public cloud for processing by the machine learning model;
(d) processing, at the public cloud, the request with the machine learning model to perform the forecasting task; and
(e) routing results of the forecasting task output by the machine learning model from the public cloud to the private cloud endpoint.
